(19) United States
(12) Patent Application Publication
(10) Pub. No.: US 2011/0260679 A1
(43) Pub. Date: Oct. 27, 2011

(54) BATTERY APPARATUS AND POWER SUPPLY SYSTEM USING THE SAME

(75) Inventor: LUNG DAI, Tu-Cheng (TW)

(73) Assignee: HON HAI PRECISION INDUSTRY CO., LTD., Tu-Cheng (TW)

(21) Appl. No.: 12/871,836

(22) Filed: Aug. 30, 2010

(30) Foreign Application Priority Data
Apr. 23, 2010 (CN) 201010154325.7

(51) Int. Cl. H02J 7/00

(52) U.S. Cl. 320/107

(57) ABSTRACT

A battery apparatus includes a battery module, a first power port, a second power port, a voltage transformer, and a switch. The first power port is connected to the battery module. The voltage transformer is configured to transform a voltage output of the battery module into a lower voltage output. The switch is connected between the battery module, the second power port, and the voltage transformer. The switch is capable of selectively connecting the battery module to the second power port or the voltage transformer. When the battery module is connected to the second power port, the battery apparatus is used as a battery power source capable of being connected to battery contacts of an external electronic device. When the battery module is connected to the voltage transformer, the battery apparatus is able to charge batteries of external electronic devices. A related power supply system is also provided.

### BACKGROUND

1. Technical Field

The present disclosure relates to battery apparatuses and, particularly, to a battery apparatus capable of being employed to provide power to various electronic devices and a power supply system having the battery apparatus.

2. Description of Related Art

Batteries having different nominal voltages for different electronic devices are normally not interchangeably replaceable for one another. For example, a battery of a notebook computer having a higher nominal voltage cannot be directly used to supply power to a mobile phone that works at a lower nominal voltage. Therefore, when traveling, if a battery of a mobile phone is used up, even if there is a notebook computer at hand, the mobile phone cannot be charged because the battery of the notebook cannot be used to supply power to the mobile phone, which is troublesome.

### BRIEF DESCRIPTION OF THE DRAWINGS

The components of the drawings are not necessarily drawn to scale, the emphasis instead being placed upon clearly illustrating the principles of a battery apparatus and a power supply system using the same. Moreover, in the drawings, like reference numerals designate corresponding parts throughout several views.

FIG. 1 is a block diagram of a battery apparatus in accordance with an exemplary embodiment.

FIG. 2 is a hardware diagram of a power supply system in accordance with an exemplary embodiment.

### DETAILED DESCRIPTION

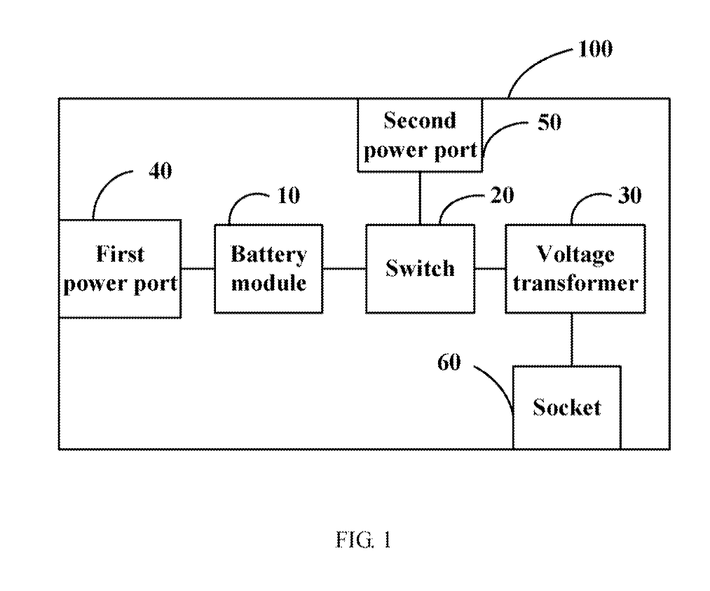

Referring to FIG. 1, a battery apparatus 100 includes a battery module 10, a switch 20, a voltage transformer 30, a first power port 40, and a second power port 50.

The switch 20 is connected among the battery module 10, the voltage transformer 30, and the second power port 50, and is used to selectively connect the battery module 10 to the voltage transformer 30 or the second power port 50. The battery module 10 is further connected to the first power port 40. An anode of the battery module 10 is connected to the first power port 40, and a cathode is connected to the switch 20.

When the battery module 10 is switched to be connected to the second power port 50, the battery apparatus 100 can be used as a battery power source which can be connected to battery contacts of an electronic device (not shown). When the battery apparatus 100 is used as the battery power source of the electronic device, the first power port 40 and the second power port 50 are respectively connected to an anode and a cathode of the electronic device that is provided, for example, in a battery compartment of the electronic device. In this embodiment, the voltage output supplied by the battery module 10 is about 19V which is a common nominal voltage required to operate a relatively larger portable electronic devices, such as notebooks, net books, and so on. Therefore, the battery apparatus 100 can be used instead of a standard battery sold with the electronic device.

When the battery module 10 is connected to the voltage transformer 30, the voltage transformer 30 transforms the voltage output of the battery module 10 into a lower voltage output for use with relatively smaller portable electronic devices, such as mobile phones, media players, PDAs, and so on. The battery apparatus 100 further includes a socket 60 connected to the voltage transformer 30, and the battery apparatus 100 can be connected to and charge batteries of the smaller electronic devices through the socket 60.

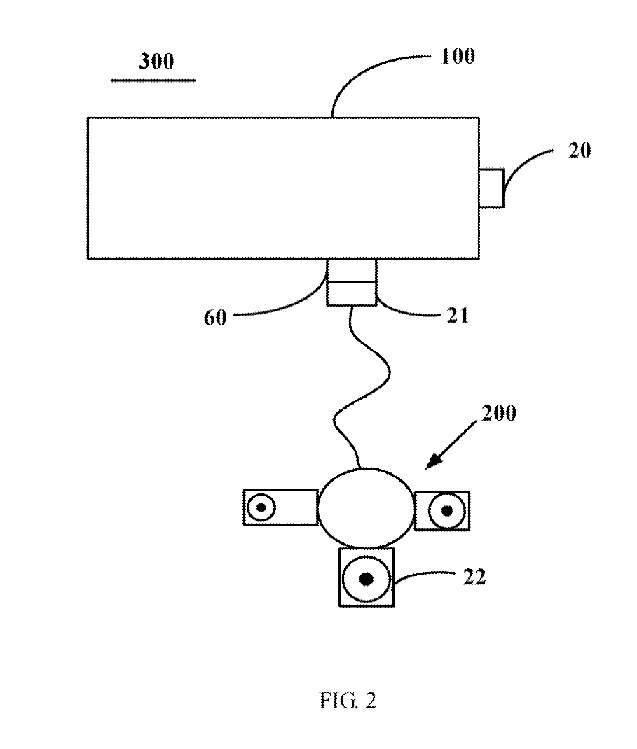

Referring to FIG. 2, a power supply system 300 includes the battery apparatus 100 and a charger 200. The charger 200 includes a plug 21 and at least one socket 22. The plug 21 can be coupled to the socket 60 of the battery apparatus 100 to receive power from the battery apparatus 100. In this embodiment, there are three sockets 22. The sockets 22 may each be configured for a different type of electronic device connectors, so that more than one kind of electronic device which has voltage requirements compatible with the charger 200 and the battery apparatus 100 can be charged by the charger 200 and the battery apparatus 100. For example, the sockets 22 may be respectively configured for a mobile phone, an MP3 player, and a PDA. The number and the type of the at least one socket 22 can vary according to need.

With such configuration, the battery apparatus 100 can be employed as a battery power source, and can also work together with the charger 200 to charge different types of electronic device.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A battery apparatus, comprising:
a battery module;
a first power port connected to the battery module;
a second power port;
a voltage transformer configured to transform a voltage output of the battery module into a lower voltage output; and
a switch connected between the battery module, the second power port, and the voltage transformer, the switch being capable of selectively connecting the battery module to the second power port or the voltage transformer;
wherein, when the battery module is connected to the second power port, the battery apparatus is used as a battery power source capable of being connected to battery contacts of an external electronic device, when the battery module is connected to the voltage transformer, the voltage output of the battery module is transformed into the lower voltage output, and the battery apparatus is able to charge batteries of external electronic devices.

2. The battery apparatus as described in claim 1 further comprising a socket connected to the voltage transformer, wherein the battery apparatus is operable to be connected to external electronic devices through the socket.

3. The battery apparatus as described in claim 1, wherein the first power port is connected to an anode of the battery module, and the switch is connected to a cathode of the battery module.

4. A power supply system, comprising:
a battery apparatus comprising:
a battery module;
a first power port connected to the battery module;
a second power port;
a voltage transformer configured to transform a voltage output of the battery module into a lower voltage output;
a switch connected between the battery module, the second power port, and the voltage transformer, the switch being capable of selectively connecting the battery module to the second power port or the voltage transformer; and
a first socket connected to the voltage transformer; and
a charger comprising:
a plug capable of being coupled to the first socket; and
at least one second socket capable of being connected to at least one external electronic device;
wherein, when the first socket is coupled to the plug, an external electronic device is connected to one of the at least one second socket, and the battery module is switched to be connected to the voltage transformer, the voltage output of the battery module is transformed into the lower voltage output, and the battery apparatus is able to charge a battery of the external electronic device connected to the one of the at least one socket.

5. The power supply system as described in claim 4, wherein the first power port is connected to an anode of the battery module, and the switch is connected to a cathode of the battery module.
